(19) United States
(12) Patent Application Publication
(10) Pub. No.: US 2004/0238987 A1
(43) Pub. Date: Dec. 2, 2004

(54) Temperature control for molds

(76) Inventor: Joseph C. Jensen, Tucson, AZ (US)

Correspondence Address: C. Robert von Hellens, CAHILL, VON HELLENS & GLAZER P.L.C., Suite 155, 2141 E. Highland Avenue, Phoenix, AZ, 85016, US

(21) Appl. No.: 10/449,280

(22) Filed: May 30, 2003

(51) Int. Cl. B29C 65/04; B29C 65/24

(52) U.S. Cl. 264/40.6; 425/508; 425/174.8 R; 425/144; 425/170

(57) ABSTRACT

A mold for forming plastic elements or for welding plastic elements to one another includes a thermocouple having its metallic elements welded to the mold to provide an accurate indication of the temperature of the mold. The metallic elements may be welded at a common location or at spaced apart locations. A circuit responsive to the temperature indication provided by the thermocouple controls the heating of the mold to maintain it at a predetermined temperature.

### BACKGROUND OF THE INVENTION

Heated molds for forming or welding plastic materials to one another have been used for many years. Generally, these molds are machined of metal to form cavities commensurate with the final shape of the article. Usually, the material(s) to be formed or welded are inserted within the mold and the mold is heated to a temperature sufficient to form or weld the materials into the configuration represented by the mold cavity. Usually, a coil is wound about the mold and heating is accomplished by RF energy applied to the coil resulting in heating by induction.

Heating of the mold to a temperature within a narrow temperature range is generally required in order to produce consistent results. This is a particular problem for the molds used in catheter forming because of the fast response time of the small molds and the need for accuracy and repeatability of the process and end result.

The conventional way of controlling the temperature of a mold is through use of a thermocouple lodged adjacent the mold. The thermocouple provides a signal in the manner of a feedback signal to control the electrical power supplied to the coil. Where temperature within a narrow range is not critical, such a thermocouple is adequate for temperature control purposes. However, there is a finite delay in heating the thermocouple through heat conduction from the mold due to the limited contact area therebetween. This can result in the surface of the mold cavity being at a higher temperature then that reflected by the thermocouple.

The net result of such heat losses and delays in transfer of heat to the thermocouple is that the signal generated by the thermocouple is inaccurate. Such inaccuracy will often result in excessive heating of the mold and overshoot of the temperature at the mold cavity surface. While it is possible to incorporate compensatory circuitry, additional expenses will be incurred and such compensatory circuitry would have to be modified as a function of the nature of the material being formed or welded, the ambient temperature as it impacts the degree of heat radiation from the mold and the location of the thermocouple on the mold.

### SUMMARY OF THE INVENTION

A thermocouple is formed of two different metals soldered or welded together and connected to a galvanometer or a potentiometer to provide an indication of an electromotive force developed as a result of a temperature difference at their junction. To obtain minimal thermal loss contact between the two metals of the thermocouple and a mold, the temperature of which is to be measured, both metals of the thermocouple are welded to a surface of the mold as a unit. Alternatively, each of the two metals of the thermocouple may be individually welded to the mold at spaced apart locations. The resulting current generated by the electromotive force developed as a function of the temperature of the mold is very accurate in reflecting the temperature of the mold and minimal thermal losses and minimal time delay of heat transfer between the mold and the thermocouple are present.

It is therefore a primary object of the present invention to provide an accurate indication reflective of the temperature of a mold used to weld plastic materials with one another to form plastic materials.

Another object of the present invention is to provide a thermocouple coupled with a mold for generating an indication accurately reflective of the temperature of the mold.

Yet another object of the present invention is to provide an accurate control signal for maintaining a mold cavity at a predetermined temperature.

Yet another object of the present invention is to provide a control signal for controlling an inductively heated mold cavity.

A further object of the present invention is to provide a thermocouple as an integral part of a mold to generate a signal reflective of the temperature of the mold.

A yet further object of the present invention is to provide a thermocouple having its bi-metallic elements welded to a mold.

A still further object of the present invention is to provide a method for accurately sensing and controlling the temperature of a mold.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 is a perspective view of a mold and elements associated therewith;

FIG. 2 is a representative cross section of the mold and certain of its related components shown in FIG. 1;

FIG. 3 is a schematic of the prior art for sensing the temperature of a mold with a thermocouple;

FIG. 4 illustrates two separated metals of a thermocouple welded to a mold at separated locations;

FIG. 5 illustrates the two metals of a thermocouple unit welded to a mold at a common location; and

FIG. 6 illustrates a block diagram of the circuitry for heating and controlling the amount of heat applied to a mold.

### DESCRIPTION OF THE PREFERRED EMBODIMENT

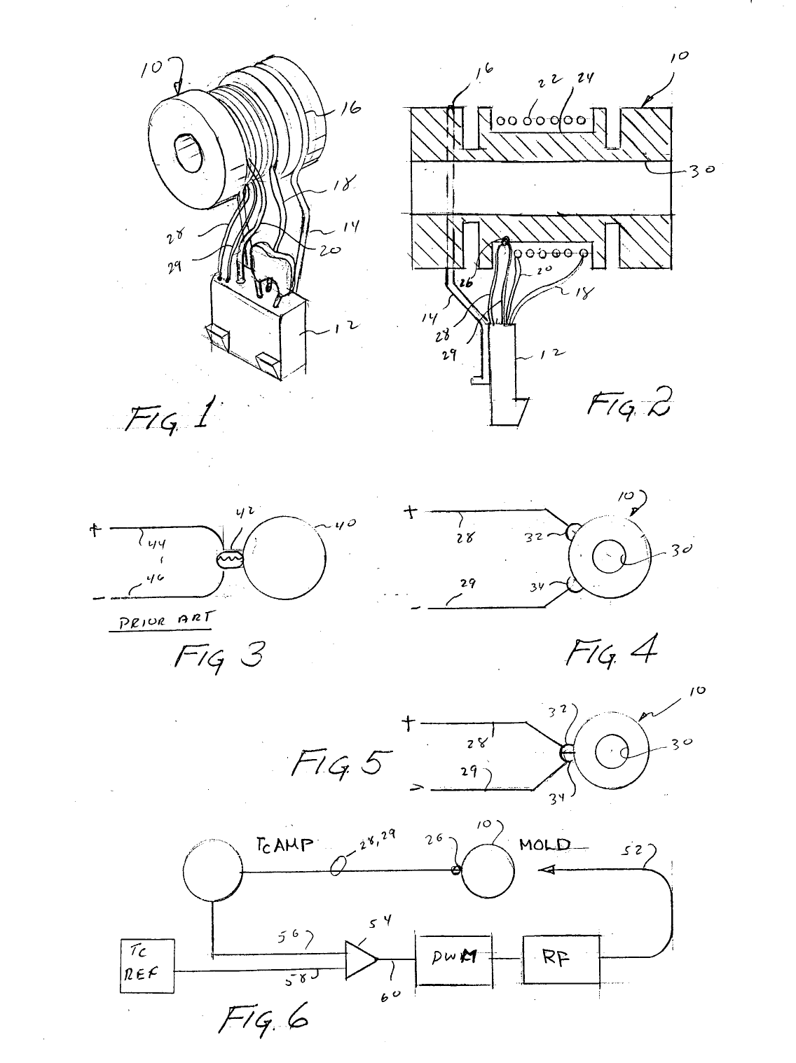

Referring to FIG. 1, there is illustrated a representative mold 10 for welding plastic materials, such as any of the various plastics, by applying heat to the materials to obtain a weld in conformance with the configuration of the mold cavity. Molds of this type may also be used to form plastic materials into a configuration commensurate with the mold cavity. A connector 12 mechanically supports the mold by a clip 14 extending therefrom into engagement with the mold. The connector also provides electrical connection to a circuit (see FIG. 6). As shown in further detail in FIG. 2, clip 14 may be in engagement with a groove 16 formed about mold 10. A pair of electrical conductors 18, 20, electrically connect a coil 22 extending about a spool 24 of the mold. Radio frequency (RF) energy is applied to the coil through conductors 18, 20 to inductively heat the mold. A thermocouple 26 is welded to the surface of spool 24. The thermocouple will provide an indication via a pair of conductors 28, 29 reflective of the temperature at the surface of the mold to which the thermocouple is welded.

Referring to FIG. 3, there is shown a conventional prior art arrangement between a mold 40 and a thermocouple 42. Generally, the thermocouple is lodged adjacent the mold with resulting losses at the interface. The thermal conduction across the interface is relatively inefficient and the temperature of the thermocouple, seldom, if ever, approaches that of the contacted surface of the mold. Hence, the signal generated by the thermocouple and transmitted through conductors 44, 46 provides an indication of a temperature less than that present at the surface of the mold cavity itself. Thus, accurate determination of the temperature at the mold cavity and acting upon the materials to be welded, is impossible to obtain. To overcome this discrepancy, compensatory circuitry or compensatory techniques have to be employed. Invariably, such compensatory schemes results in overshooting the desired temperature at the mold cavity and overheating or under heating the mold cavity.

Referring to FIG. 4, there is shown a mold 10, such as the mold illustrated in FIGS. 1 and 2, having a mold cavity 30. The mold cavity shown is particularly adapted for butt welding plastic tubing. Each of two metallic elements 32, 34 of a thermocouple (26) is welded or soldered to mold 10 at spaced apart locations. Thereby each metallic element becomes an integral part of the mold. With such welding or soldering, thermal conduction from the mold to each metallic element of the thermocouple is greatly enhanced and the thermal losses and time delay of heat transfer attendant previous uses of a thermocouple are avoided. The resulting indication present on conductors 28, 29 is very, very closely reflective of the actual temperature at the surface of mold cavity 30.

Referring to FIG. 5, there is shown an alternative mechanical junction between thermocouple 26 and mold 10. Each metallic element 32, 34 of a conventional thermocouple 26 is welded or soldered to mold 10 at a common location. With such form of attachment, thermal conductivity across the interface between the mold and the thermocouple is greatly enhanced. Thereby, the indication generated by the thermocouple across conductors 28, 29 is very very close to and reflective of the temperature at the surface of mold cavity 30.

FIG. 6 illustrates a block diagram of the major components attendant operation of the present invention. A pulse width modulator (PWM) controls an oscillator formed as part of a circuit for generating a radio frequency (RF) signal. The RF signal is conveyed through a coaxial conductor 52 (conductors 18, 20 in FIGS. 1 and 2) to mold 10 to heat the mold by induction. Thermocouple 26 generates an indication or signal on conductors 28, 29 as a function of the temperature of the mold at the location the thermocouple is welded or soldered thereto. The signal is amplified through an amplifier (T_{C}AMP) and conveyed to a differential amplifier 54 via conductor 56. The differential amplifier compares the signal received from the thermocouple with a temperature reference signal developed by a temperature reference circuit (T_{C}REF) and conveyed via conductor 58. The output of the differential amplifier is conveyed via conductor 60 to the pulse width modulator (PWM) to increase or decrease the power control signal to cause an increase or decrease of the RF power applied to the mold in order to obtain a temperature match between the signal generated by the thermocouple and the signal generated by the temperature reference circuit (T_{C}REF).

In summary, by welding or soldering the bimetallic elements of a thermocouple to a mold for welding or forming materials, the temperature sensed by the thermocouple is essentially equivalent to the temperature in the mold cavity and the thermal losses and time delays attendant prior art thermocouple controlled molds are completely avoided.

We claim:

1. Apparatus for forming a material with heat, said apparatus comprising in combination:
a) a mold;
b) a coil for inductively heating said mold; and
c) a thermocouple for providing an indication of the temperature of said mold, said thermocouple including two metallic elements welded to said mold.

2. An apparatus as set forth in claim 1 wherein said thermocouple comprises said metallic elements joined together as a unit with each of said metallic elements being welded to said mold at a common location.

3. An apparatus as set forth in claim 1 wherein said thermocouple comprises two separate metallic elements, each of said metallic elements being welded to said mold at spaced apart locations.

4. An apparatus as set forth in claim 1 including a source of RF energy for energizing said coil and a control circuit responsive to said thermocouple for controlling the power output of said source of RF energy.

5. An apparatus as set forth in claim 4 wherein said control circuit includes a differential amplifier, a source of a temperature reference signal coupled to said differential amplifier and an amplifier responsive to said thermocouple coupled to said differential amplifier.

6. An apparatus as set forth in claim 5 including a pulse width modulator responsive to said differential amplifier for controlling the output of said source of RF energy as a function of the indication from said thermocouple.

7. Temperature sensing apparatus for providing an indication of the temperature of a mold, said apparatus comprising a thermocouple having each of a pair of metallic elements welded to the mold.

8. An apparatus as set forth in claim 7 wherein said thermocouple comprises a unit of a pair of bimetallic elements, each of said elements being welded to the mold at a common location.

9. An apparatus as set forth in claim 7 wherein said thermocouple comprises a pair of separate and apart metallic elements, each of said elements being welded to the mold at a location apart from the other.

10. Apparatus for welding separate plastic materials to one another, said apparatus comprising in combination:
a) a mold;
b) means for heating the mold;
c) a thermocouple comprising a pair of metallic elements welded to said mold for generating an indication reflective of the temperature of said mold; and
d) a circuit responsive to the indication for controlling operation of said heating means to maintain the mold at a predetermined temperature.

11. An apparatus as set forth in claim 10 wherein said metallic elements are joined with one another, each of said metallic elements being welded at a common location on said mold.

12. An apparatus as set forth in claim 10 wherein said metallic elements are separated from one another, said metallic elements being welded at spaced apart locations on said mold.

13. A method for welding plastic parts with one another in a mold, said method comprising the steps of:
a) heating the mold;
b) providing an indication of the temperature of the mold with a thermocouple welded to the mold; and
c) controlling said step of heating as a function of the temperature indication of the thermocouple.

14. The method as set forth in claim 13 wherein said step of providing is carried out by a pair of bimetallic elements of the thermocouple welded to the mold at a common location on the mold.

15. The method as set forth in claim 13 wherein said step of providing is carried out by a pair of bimetallic elements of the thermocouple welded to the mold at spaced apart locations on the mold.

16. A method for forming parts in a mold, said method comprising the steps of:
a) heating the mold;
b) providing an indication of the temperature of the mold with a thermocouple welded to the mold; and
c) controlling said step of heating as a function of the temperature indication of the thermocouple.

17. The method as set forth in claim 16 wherein said step of providing is carried out by a pair of bi-metallic elements of the thermocouple welded to the mold at a common location on the mold.

18. The method as set forth in claim 16 wherein said step of providing is carried out by a pair of bimetallic elements of the thermocouple welded to the mold at spaced apart locations on the mold.
